(19) United States
(12) Patent Application Publication
(10) Pub. No.: US 2026/0072464 A1
(43) Pub. Date: Mar. 12, 2026

(54) SWITCH DEVICE

(71) Applicant: KABUSHIKI KAISHA TOKAI RIKA DENKI SEISAKUSHO, Aichi (JP)

(72) Inventors: Rika KIKOJIMA, Aichi (JP); Hidetaka NOMURA, Aichi (JP); Kenji MURATA, Aichi (JP); Motoya TAKEUCHI, Aichi (JP)

(73) Assignee: KABUSHIKI KAISHA TOKAI RIKA DENKI SEISAKUSHO, Aichi (JP)

(21) Appl. No.: 19/135,122

(22) PCT Filed: Dec. 4, 2023
(86) PCT No.: PCT/JP2023/043301

§ 371 Date: Jun. 3, 2025

(30) Foreign Application Priority Data
Dec. 5, 2022 (JP) 2022-194414

(51) Int. Cl. G05G 1/01; B60J 7/043; G05G 1/02

(52) U.S. Cl. CPC G05G 1/01; G05G 1/02; B60J 7/043

(57) ABSTRACT

A switch device (1) includes a first part to be operated (11), a second part to be operated (12), and a third part to be operated (13). The first part to be operated (11) is configured to receive an operation of displacing, in a first direction, an opening/closing body (111) for changing the opening degree of an opening (O). The second part to be operated (12) is configured to receive an operation for displacing the opening/closing body (111) in a second direction opposite to the first direction. The third part to be operated (13) is configured to receive an operation for changing the amount of light passing through the opening/closing body (111) and the opening (O). The first part to be operated (11) is disposed in the first direction when viewed from the third part to be operated (13). The second part to be operated (12) is disposed in the second direction when viewed from the third part to be operated (13).

### TECHNICAL FIELD

The present disclosure relates to a switch device.

### BACKGROUND ART

JP2016-002927A discloses a switch device to be mounted on a vehicle including a roof glass and a sunshade. The switch device includes a first switch and a second switch. The first switch receives an operation of changing an opening degree of an opening provided in a roof portion of the vehicle by sliding the roof glass. The second switch receives an operation of changing an amount of light transmitting through the roof glass by sliding the sunshade.

### SUMMARY OF INVENTION

### Technical Problem

The switch device is required to save space.

### Solution to Problem

An example of an aspect provided by the present disclosure is a switch device including:
a first operated portion configured to receive an operation of displacing an opening and closing body in a first direction, the opening and closing body being configured to change an opening degree of an opening;
a second operated portion configured to receive an operation of displacing the opening and closing body in a second direction opposite to the first direction; and
a third operated portion configured to receive an operation of changing an amount of light passing through the opening and closing body and the opening, in which
the first operated portion is disposed in the first direction when viewed from the third operated portion, and
the second operated portion is disposed in the second direction when viewed from the third operated portion.

According to the above configuration, it is possible for the switch device, which includes the first operated portion and the second operated portion that receive operations of changing the opening degree of the opening by the opening and closing body and the third operated portion that receives an operation of changing the amount of light passing through the opening and the opening and closing body by the sunshade, to save space. Specifically, it is possible to prevent an increase in an occupied area of the first operated portion, the second operated portion, and the third operated portion in a direction intersecting the first direction and the second direction. Accordingly, a degree of freedom in layout of the switch device can be increased even in a case of a limited area in which the switch device may be installed.

An example of an aspect provided by the present disclosure is a switch device including:
a first operated portion configured to receive an operation of displacing a first opening and closing body in a first direction, the first opening and closing body configured to change an opening degree of an opening;
a second operated portion configured to receive an operation of displacing the first opening and closing body in a second direction opposite to the first direction; and
a third operated portion configured to receive an operation of displacing a second opening and closing body in the first direction and the second direction, the second opening and closing body being configured to be displaced to change the opening degree of the opening, in which
the first operated portion is disposed in the first direction when viewed from the third operated portion, and
the second operated portion is disposed in the second direction when viewed from the third operated portion.

According to the above configuration, it is possible for the switch device, which includes the first operated portion and the second operated portion that receive operations of changing the opening degree of the opening by the two opening and closing bodies and the third operated portion, to save space. Specifically, it is possible to prevent an increase in an occupied area of the first operated portion, the second operated portion, and the third operated portion in a direction intersecting the first direction and the second direction. Accordingly, a degree of freedom in layout of the switch device can be increased even in a case of a limited area in which the switch device may be installed.

### BRIEF DESCRIPTION OF DRAWINGS

FIG. 1 illustrates a vehicle cabin of a vehicle on which a switch device according to an embodiment is mounted.

FIG. 2 shows a functional configuration of the switch device in FIG. 1.

FIG. 3 illustrates an appearance of an operated member of the switch device in FIG. 1 in a plan view.

FIG. 4 illustrates an appearance of the operated member viewed from a direction of an arrow IV in FIG. 3.

FIG. 5 illustrates a configuration of the operated member according to another example.

### DESCRIPTION OF EMBODIMENTS

Hereinafter, an embodiment will be described with reference to the accompanying drawings. In the drawings used in the following description, a scale is appropriately changed to make elements recognizable in size.

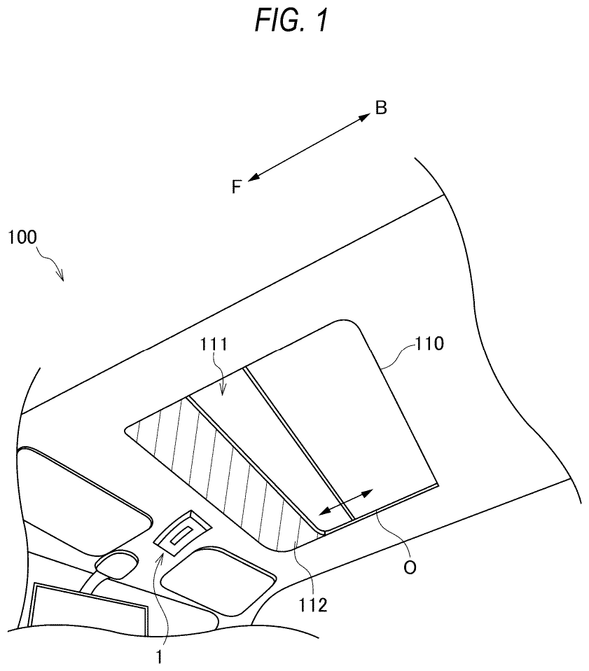

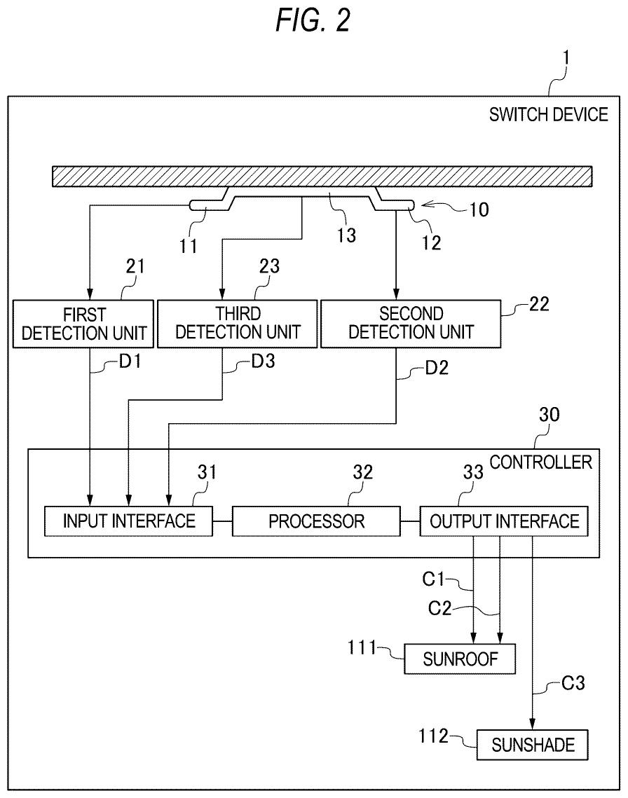

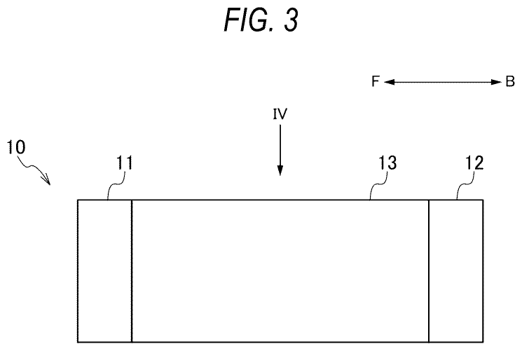

FIG. 1 illustrates a switch device 1 mounted on a vehicle 100 according to an embodiment. FIG. 2 shows a functional configuration of the switch device 1. FIG. 3 illustrates the switch device 1 viewed from inside of the vehicle 100. In FIGS. 1 and 3, an arrow F indicates a forward direction of the vehicle 100. An arrow B indicates a rearward direction of the vehicle 100.

A term “front-rear direction” used in the present specification means a direction along the forward direction and the rearward direction.

The switch device 1 is installed on a ceiling 110. The vehicle 100 is an example of a moving body. In other words, the switch device 1 is supported on the ceiling 110. The ceiling 110 is an example of a support. The ceiling 110 is formed with an opening O.

A roof glass 111 is mounted on the vehicle 100. The roof glass 111 covers the opening O. The roof glass 111 is configured to be displaced in the front-rear direction by an operation of a drive mechanism (not shown). By displacing the roof glass 111 in the front-rear direction, an opening degree of the opening O can be changed. The roof glass 111 is an example of an opening and closing body.

A sunshade 112 is mounted on the vehicle 100. The sunshade 112 covers the roof glass 111 and the opening O. The roof glass 111 is configured to be displaced in the front-rear direction by an operation of a drive mechanism (not shown). The sunshade 112 has a lower visible light transmittance than the roof glass 111. By displacing the sunshade 112 in the front-rear direction, an amount of light passing through the opening O and the roof glass 111 can be changed. The sunshade 112 is an example of a dimming body.

The switch device 1 includes an operated member 10. The operated member 10 is configured to receive an operation by a finger or the like of an occupant of the vehicle 100. The operated member 10 includes a first operated portion 11, a second operated portion 12, and a third operated portion 13. The first operated portion 11 is configured to receive an operation of displacing the roof glass 111 in the forward direction. The second operated portion 12 is configured to receive an operation of displacing the roof glass 111 in the rearward direction. The third operated portion 13 is configured to receive an operation of displacing the sunshade 112 in the front-rear direction. The forward direction is an example of a first direction. The rearward direction is an example of a second direction.

The switch device 1 includes a first detection unit 21, a second detection unit 22, and a third detection unit 23. The first detection unit 21 is configured to output, to a controller 30, a first detection signal DI corresponding to the operation performed by the occupant on the first operated portion 11. The second detection unit 22 is configured to output, to the controller 30, a second detection signal D2 corresponding to the operation performed by the occupant on the second operated portion 12. The third detection unit 23 is configured to output, to the controller 30, a third detection signal D3 corresponding to the operation performed by the occupant on the third operated portion 13. Each of the first detection signal D1, the second detection signal D2, and the third detection signal D3 may be an analog signal or a digital signal.

The switch device 1 further includes the controller 30. The controller 30 includes an input interface 31, a processor 32, and an output interface 33. The input interface 31 is a hardware interface configured to receive the first detection signal D1, the second detection signal D2, and the third detection signal D3. In a case where at least one of the first detection signal D1, the second detection signal D2, and the third detection signal D3 is an analog signal, the input interface 31 includes an appropriate conversion circuit including an A/D converter.

The processor 32 is configured to cause the output interface 33 to output a first control signal C1 when determining that the first detection signal DI received by the input interface 31 corresponds to a prescribed operation. The processor 32 is configured to cause the output interface 33 to output a second control signal C2 when determining that the second detection signal D2 received by the input interface 31 corresponds to a prescribed operation. The processor 32 is configured to cause the output interface 33 to output a third control signal C3 when determining that the third detection signal D3 received by the input interface 31 corresponds to a prescribed operation.

Each of the first control signal C1, the second control signal C2, and the third control signal C3 may be an analog signal or a digital signal. The output interface 33 is a hardware interface. In a case where at least one of the first control signal C1, the second control signal C2, and the third control signal C3 is an analog signal, the output interface 33 includes an appropriate conversion circuit including a D/A converter.

The first control signal C1 is configured to cause a drive mechanism (not shown) to displace the roof glass 111 in the forward direction. The second control signal C2 is configured to cause a drive mechanism (not shown) to displace the roof glass 111 in the rearward direction. The third control signal C3 is configured to cause a drive mechanism (not shown) to displace the sunshade 112 in the forward direction or in the rearward direction.

As illustrated in FIGS. 2 and 3, the first operated portion 11 is disposed in the forward direction when viewed from the third operated portion 13. The second operated portion 12 is disposed in the rearward direction when viewed from the third operated portion 13. In other words, the first operated portion 11, the third operated portion 13, and the second operated portion 12 are arranged in this order in a row in the front-rear direction.

According to such a configuration, it is possible for the switch device 1, which includes the first operated portion 11 and the second operated portion 12 that receive operations of changing the opening degree of the opening O by the roof glass 111 and the third operated portion 13 that receives an operation of changing the amount of light passing through the opening O and the roof glass 111 by the sunshade 112, to save space. Specifically, it is possible to prevent an increase in an occupied area of the first operated portion 11, the second operated portion 12, and the third operated portion 13 in a direction intersecting the first direction and the second direction. Accordingly, a degree of freedom in layout of the switch device 1 can be increased in the vehicle 100 having a limited area in which the switch device 1 may be installed.

In the present embodiment, the sunshade 112 can change the opening degree of the opening O by displacement in the front-rear direction. In other words, the opening degree of the opening O can be changed by two opening and closing bodies. From this viewpoint, the roof glass 111 may be an example of the first opening and closing body. The sunshade 112 may be an example of the second opening and closing body.

That is, it is possible for the switch device 1, which includes the first operated portion 11 and the second operated portion 12 that receive operations of changing the opening degree of the opening O by the roof glass 111 and the sunshade 112 that are two opening and closing bodies and the third operated portion 13, to save space. Specifically, it is possible to prevent an increase in an occupied area of the first operated portion 11, the second operated portion 12, and the third operated portion 13 in a direction intersecting the first direction and the second direction. Accordingly, a degree of freedom in layout of the switch device 1 can be increased in the vehicle 100 having a limited area in which the switch device 1 may be installed.

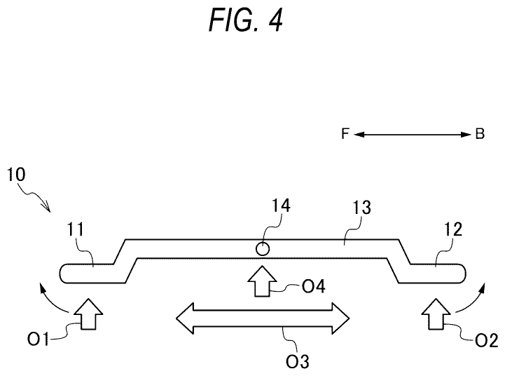

FIG. 4 illustrates an appearance of the operated member 10 viewed from a direction of an arrow IV in FIG. 3. The third operated portion 13 is configured to receive an operation in a direction different from that of operations on the first operated portion 11 and the second operated portion 12.

The first operated portion 11 is configured to receive an operation O1 that is a push-in operation. The second operated portion 12 is configured to receive an operation O2 that is a push-in operation in the same direction as that of the operation O1.

The third operated portion 13 is configured to receive an operation in a direction different from that of operations on the first operated portion 11 and the second operated portion 12. Specifically, the third operated portion 13 is configured to receive an operation of the occupant by detecting approach or contact of a part of a body of the occupant such as a finger. The third operated portion 13 is configured to receive an operation O3 that is an operation of swiping a surface of the third operated portion 13 with a finger or the like in the forward direction or the rearward direction.

According to such a configuration, operations of displacing the roof glass 111 and an operation of displacing the sunshade 112 are clearly distinguished by directions of the operations. Accordingly, displacement of both the roof glass 111 and the sunshade 112 can be controlled by the common switch device 1, and a probability of operational confusion can be reduced.

The first operated portion 11, the second operated portion 12, and the third operated portion 13 are integrally formed. The operated member 10 is configured to pivot about a rotation shaft 14 according to operations on the first operated portion 11 and the second operated portion 12. That is, the switch device 1 is a seesaw switch.

According to such a configuration, it is possible to reduce the number of components for enabling the switch device 1 to receive operations in different directions. Further, design of the switch device 1 is improved.

The third operated portion 13 is configured to receive two types of operations. Specifically, the third operated portion 13 is configured to receive the operation O3 that is an operation of swiping the surface of the third operated portion 13 with a finger or the like in the first direction or the second direction, and an operation O4 of performing at least one of starting and stopping the displacement of the sunshade 112 in a manner different from that of the operation O3. In the present embodiment, the operation O4 is a tap operation of lightly tapping the surface of the third operated portion 13. A place where the tap operation is performed is freely selected. A state of the third detection signal D3 output from the third detection unit 23 differs between in a case where the operation O3 is performed and in a case where the operation O4 is performed.

The processor 32 of the controller 30 is configured to determine a direction of the operation O3 performed on the third operated portion 13, based on the third detection signal D3 input to the input interface 31. Specifically, the processor 32 is configured to designate whether to displace the sunshade 112 in the forward direction or the rearward direction, based on a change direction of an operated position corresponding to the third detection signal D3.

Subsequently, when determining that the third detection signal D3 corresponding to the operation O4 is input to the input interface 31, the processor 32 outputs, from the output interface 33, the second control signal C2 for starting the displacement of the sunshade 112 in a designated direction. When detecting that the operation O4 is performed again, the processor 32 stops the displacement of the sunshade 112. In other words, a displacement amount of the sunshade 112 is determined by the operation O4. The operation O3 is an example of a first operation. The operation O4 is an example of a second operation.

When the displacement amount of the sunshade 112 is adjusted by the operation O3 alone, it is necessary to ensure a length dimension of the third operated portion 13 for good operability. However, according to the above configuration, the sunshade 112 is operated by the operation O3 for determining the displacement direction and the operation O4 for determining the displacement amount. Accordingly, an increase in the length dimension of the third operated portion 13 can be prevented, and thus it is possible to provide the switch device 1 in which both space-saving property and operability are achieved.

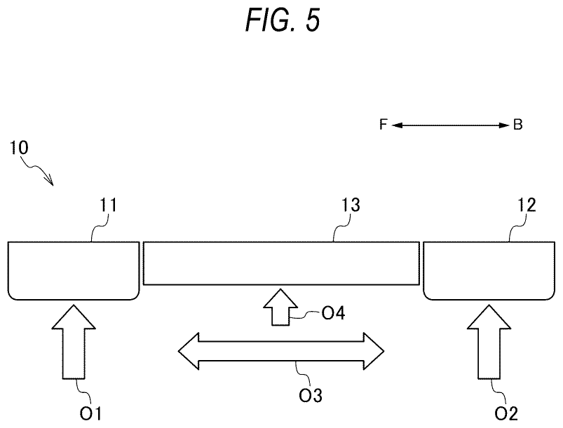

FIG. 5 shows an appearance of the operated member 10 according to another example. In the example, the first operated portion 11, the second operated portion 12, and the third operated portion 13 are provided as separate members. Accordingly, the first operated portion 11 and the second operated portion 12 are displaced relative to the third operated portion 13. In other words, the second operated portion 12 and the third operated portion 13 are not displaced even in a case where the operation O1, which is a push-in operation on the first operated portion 11, is performed. Similarly, the first operated portion 11 and the third operated portion 13 are not displaced even in a case where the operation O2, which is a push-in operation on the second operated portion 12, is performed.

According to such a configuration, displacement associated with an operation on each of the first operated portion 11 and the second operated portion 12 can be made independent from the third operated portion 13. Accordingly, it is possible to prevent a situation in which an operation on a specific operated portion unintentionally affects another operated portion.

The processor 32 having various functions as described above may be implemented by a dedicated integrated circuit such as a microcontroller, an ASIC, and an FPGA that includes a storage element in which computer programs for implementing these functions are pre-installed.

The processor 32 may be implemented by a general-purpose microprocessor that operates in cooperation with a general-purpose memory. Examples of the general-purpose microprocessor include CPU, MPU, and GPU. Examples of the general-purpose memory include ROM and RAM. In this case, the ROM may store computer programs for implementing various functions. The general-purpose microprocessor designates at least a part of the computer programs stored on the ROM, loads the designated computer program on the RAM, and executes the above-described processing in cooperation with the RAM.

The processor 32 may be implemented by a combination of a general-purpose microprocessor and a dedicated integrated circuit.

The above-described configurations are merely examples for facilitating understanding of the present disclosure. The configuration examples may be appropriately modified or combined with other configurations without departing from the gist of the present disclosure.

In the above embodiment, the opening and closing body and the dimming body are displaced by the switch device 1, and the amount of light passing through the opening and the opening and closing body is changed by the dimming body. However, the dimming body may not necessarily be displaced. For example, a dimming glass may be used instead of the sunshade 112. The dimming glass is, for example, glass having visible light transmittance that changes in accordance with an applied voltage. In this case, the dimming glass may not be displaced by an operation on the second operated portion. When the second operated portion 12 is operated, the controller 30 changes the amount of light passing through the opening O and the roof glass 111 by changing the voltage applied to the dimming glass. In this case, the roof glass 111 is an example of an opening and closing body, and the dimming glass is an example of a dimming body.

In the above embodiment, two opening and closing bodies are displaced by the switch device 1, and the amount of light passing through the opening and one of the opening and closing bodies is changed by the other one of the opening and closing bodies. However, the number of opening and closing bodies is not necessarily two as long as the amount of light passing through the opening and the opening and closing body can be changed. For example, the roof glass 111 may be a dimming glass. In this case, when the second operated portion 12 is operated, the controller 30 changes the amount of light passing through the opening O and the roof glass 111 by changing the voltage applied to the dimming glass. In this case, the roof glass 111 is an example of an opening and closing body and example of a dimming body.

Further, the opening and closing body and the dimming body may be integrally formed. For example, one dimming glass that changes the opening degree of the opening may have both a function as the opening and closing body and a function as the dimming body. When the first operated portion is operated, the controller may displace the dimming glass to change the opening degree of the opening. When the second operated portion is operated, the controller may change the voltage applied to the dimming glass to change the light transmittance of the dimming glass.

Further, the switch device does not necessarily receive an operation on the dimming body that changes the amount of light passing through the opening and the opening and closing body. For example, the switch device of the present disclosure may be applied to a double window, and the first operated portion may receive an operation on one window and the second operated portion receives an operation on the other window.

In the above embodiment, the switch device 1 is a seesaw switch. The operated member 10 is configured to pivot about the rotation shaft 14 according to operations on the first operated portion 11 and the second operated portion 12. However, the operated member 10 is not limited to an example of including the rotation shaft 14. For example, the switch device may receive an operation by bending deformation of the operated member. A portion that receives an input by bending deformation may be only the first operated portion and the second operated portion, or operations on the first operated portion, the second operated portion, and the third operated portion may be received by bending deformation of the entire operated member.

Another example of an operation received by the operated member 10 is not limited to an operation by displacement or bending deformation of the operated member 10. For example, in a case where the operated member includes a pressure-sensitive sensor, an operation position is specified without displacement of the operated member or bending deformation of the operated member, and thus the first operated portion, the second operated portion, and the third operated portion can receive an operation on each operated portion.

Further, the third operated portion 13 may receive a “flick operation” that is an operation of flicking the surface of the third operated portion 13 with a finger or the like in the first direction or the second direction, instead of the “swiping operation” that is an operation of swiping the surface of the third operated portion 13 with a finger or the like. The “swiping operation” may be an operation in which a contact position of a finger or the like on the surface of the third operated portion 13 changes at a speed less than a threshold. The “flick operation” may be an operation in which a contact position of a finger or the like on the surface of the third operated portion 13 changes at a speed equal to or higher than a threshold. The third operated portion 13 may receive only one of the “swiping operation” and the “flick operation”, or may receive both the “swiping operation”and the “flick operation”.

In the above embodiment, the switch device 1 is installed on the ceiling 110 of the vehicle 100. In this case, the first direction in which the first operated portion 11 and the second operated portion 12 are arranged substantially coincides with the second direction in which the roof glass 111 and the sunshade 112 are arranged. However, for example, the switch device may be provided on a side wall surface or a console box of the vehicle. That is, the side wall surface and the console box may be examples of a support. In this case, the first direction may be different from the second direction.

The switch device 1 may also be mounted on a moving body other than the vehicle 100. Examples of the moving body include a train, an aircraft, and a ship. The moving body may not require a driver.

The switch device 1 does not necessarily be mounted on a moving body. For example, the switch device 1 may control an operation of an opening and closing body that changes an opening degree of an opening provided in a house or a facility, and an operation of a dimming body that changes an amount of light passing through the opening and closing body and the opening. An example of a combination of the opening and closing body and the dimming body includes a window and a blind.

One of two opening and closing bodies displaced by the switch device 1 does not necessarily have a dimming function. For example, the first operated portion 11 may change an opening degree of an opening of a first window constituting a double window. The second operated portion 12 may cause a second window constituting the double window to change the opening degree of the opening. In this case, the first window is an example of a first opening and closing body. The second window is an example of a second opening and closing body.

Contents of JP2022-194414A submitted on Dec. 5, 2022 are incorporated herein by reference as a part of the present disclosure.

1. A switch device comprising:
a first operated portion configured to receive an operation of displacing an opening and closing body in a first direction, the opening and closing body being configured to change an opening degree of an opening;
a second operated portion configured to receive an operation of displacing the opening and closing body in a second direction opposite to the first direction; and
a third operated portion configured to receive an operation of changing an amount of light passing through the opening and closing body and the opening,
wherein the first operated portion is disposed in the first direction when viewed from the third operated portion, and
the second operated portion is disposed in the second direction when viewed from the third operated portion.

2. The switch device according to claim 1,
wherein the third operated portion is configured to receive an operation of displacing a dimming body arranged along the second direction and in parallel to the opening and closing body.

3. A switch device comprising:
a first operated portion configured to receive an operation of displacing a first opening and closing body in a first direction, the first opening and closing body configured to change an opening degree of an opening;
a second operated portion configured to receive an operation of displacing the first opening and closing body in a second direction opposite to the first direction; and
a third operated portion configured to receive an operation of displacing a second opening and closing body in the first direction and the second direction, the second opening and closing body being configured to be displaced to change the opening degree of the opening,
wherein the first operated portion is disposed in the first direction when viewed from the third operated portion, and
the second operated portion is disposed in the second direction when viewed from the third operated portion.

4. The switch device according to any one of claims 1 to 3,
wherein the third operated portion is configured to receive an operation in a direction different from a direction of an operation on each of the first operated portion and the second operated portion.

5. The switch device according to claim 4,
wherein the first operated portion, the second operated portion, and the third operated portion are integrally formed, and
the third operated portion is configured to pivot about a pivot shaft according to an operation on the first operated portion or the second operated portion.

6. The switch device according to any one of claims 1 to 3,
wherein each of the first operated portion and the second operated portion is configured to be displaced in a different direction relative to the third operated portion.

7. The switch device according to claim 2,
wherein the third operated portion is configured to receive a first operation of designating whether a direction in which the dimming body is displaced is the first direction or the second direction by swiping a surface of the third operated portion in the first direction or the second direction, and a second operation of causing the dimming body to perform at least one of starting and stopping displacement in a manner different from the first operation.

8. The switch device according to claim 3,
wherein the third operated portion receives a first operation of designating whether a direction in which the second opening and closing body is displaced is the first direction or the second direction by swiping a surface of the third operated portion in the first direction or the second direction, and a second operation of causing the second opening and closing body to perform at least one of starting and stopping displacement in a manner different from the first operation.

9. The switch device according to any one of claims 1 to 8,
wherein the switch device is mounted on a moving body.
